(19) United States
(12) Patent Application Publication
(10) Pub. No.: US 2006/0218061 A1
(43) Pub. Date: Sep. 28, 2006

(54) INTEGRATED FINANCIAL SERVICES PLATFORM

(75) Inventor: Imad MOULINE, Braintree, MA (US)

Correspondence Address: SMITH FROHWEIN TEMPEL GREENLEE BLAHA, LLC, P.O. BOX 88148, ATLANTA, GA, 30356, US

(73) Assignee: SECURITY FIRST TECHNOLOGIES CORP., Atlanta, GA (US)

(21) Appl. No.: 10/907,252

(22) Filed: Mar. 25, 2005

(51) Int. Cl. G06Q 40/00

(52) U.S. Cl. 705/35

(57) ABSTRACT

An integrated financial services platform that allows for the definition of applications, rules and data necessary to fulfill financial services to be created one time and either loaded into workstation devices that fulfill the financial services or, loaded into a server that fulfills the financial services from requesting devices. The workstation devices can operate autonomously but are continuously updated as changes in the definition of the applications, rules and data are deployed. The server houses the master definition of the applications, rules and data making the fulfillment of the financial services available to a variety of devices access the server. Thus, the provision of the financial services is integrated regardless of the access point that request the system to fulfill the financial service.

### CROSS-REFERENCE TO RELATED APPLICATIONS

This application is related to U.S. Provisional Application for patent having a title of CLIENT PLATFORM ARCHITECTURE and Ser. No. 10/907,199 and filed on the same date as this application—such application is incorporated herein by reference.

### BACKGROUND OF THE INVENTION

This invention relates to the field of distributed computer systems and, more particularly to implementing an ASP based distributed system in a low-error and high-reliability environment.

In the early days of distributed computing, systems typically employed the use of mainframe computers to perform back end processing and users of the computer system simply utilized dumb-terminals that would be communicatively connected to the main frame. The dumb-terminals simply acted as an input to control the mainframe through the use of a key board and an output to display computed results through a monitor. In the late 1970's and early 1980's technology advances brought about the use of personal computers that were instrumental in off loading some of the processor requirements of the mainframe computers and brought the processing power to the users work station.

Upon the introduction of the Microsoft Disk Operating System (MSDOS) operating on an Intel based microprocessor platform, the personal computer migrated into a stand alone system. The advantages of the mainframe computers included the ability to share resources, such as processing power, memory storage, applications and data. The advantages of the personal computers included the ability to obtain significant processing power at a relatively inexpensive price in comparison to mainframe computers, as well as minimizing maintenance and the need for system operators. However, in many environments there was a need for both capabilities.

As technology advanced, networking solutions came into existence that blended both worlds. Users could utilize personal computers but still gain the benefit of shared resources through the use of a central server running networking software such as Novell.

Today we have sophisticated technology that allows personal computers to be networked through globally reaching networks, sharing resources, applications, data and enabled to communicate with each other. As is typical with most technological advancements, many additional issues arise as the technology is employed in various environments. Issues faced by companies or businesses employing the use of distributed computing include reliability, upgrading the technology or application programs, security, network connectivity and the like.

Within financial institutions, such as banking companies, the issues surrounding the deployment of distributed computing are quite evident. Conventionally, teller systems were developed as rich clients using native technology. The rich clients carry substantial maintenance cost in that each system must be individual maintained, upgraded and serviced. With the advent of web-based applications, there is a shift in many industries to move native applications to web-based applications. However, in a banking environment, such a technology migration is not readily feasible because the use of web-based applications pose significant problems for bank branch teller devices.

Three are at least three fundamental requirements for such a teller system: accuracy, efficiency and customer focus.

Accuracy directly reflects on the effectiveness of a teller system. Several techniques have been proven effective to ensure accuracy for teller systems. One such technique is interactive validation. Interactive validation is focused on preventing a teller from entering inaccurate data into the system as soon as possible. Another technique is simplified transaction presentation. Simplified transaction presentation focuses on simplifying the encapsulation of a transaction to help ensure accuracy.

Efficiency is another fundamental requirement for teller systems. The main focus of efficiency is minimizes the amount to time it takes a teller to perform his or her tasks. Thus, efficiency can directly translate into shorter queues at the teller counter, which further translates into more transactions per teller and better customer service. Thus, banks are very focused on increasing the efficiency of the teller system. Banks have found that at least three key characteristics can have a significant impact on efficiency.

First of all, keyboard based systems are preferred. Tellers are typically extremely efficient with the use and operation of a keyboard. With the introduction of new technologies such as a mouse or other pointing instruments, the teller efficiency is adversely affected. Secondly, because tellers are very efficient at entering information into the teller system, the employment of in-screen updates and/or validations can adversely affect the teller's efficiency. For instance, if the teller must wait for the network to validate the entered data and update the screen at periodic intervals, the typical teller must wait for the response from the network. Thus, utilizing such techniques to improve the accuracy of the data is diametrically opposed to maintaining efficient operation. Thus, any technique that utilizes such a validation technique should not block the user from entering transaction data. Another characteristic that adversely affects efficiency is the use of screen scrolling. When the teller is required to use scroll bars or other similar techniques to view other portions of an input screen, implementers have determined that the tellers are more prone to make mistakes.

Finally, customer focus is a third fundamental requirement for teller systems. Banks are increasingly starting to look at branches as more than just customer convenience centers. Instead, branch offices are perceived to become sales advisory centers, with every interaction with the customer as a potential opportunity to up-sell or cross-sell additional services or products. Consequently, banking centers are striving to implement other features in the teller systems that will enable the teller systems to provide:

Integration across channels;

A unified customer view across all interactions;

Service inherent in all transactions; and

Advice based sales.

Terms of art that are used in the industry to describe systems such as teller systems include the terms “thin-client” and “rich-client”. Thin-clients and rich-clients represent two ends of a spectrum of system sophistication. They both carry their own complexities in implementation within a teller system.

A rich-client is typically a personal computer or other device with significant computing capabilities that operates on a network. The rich-client is designed to operate with or without access to the server or a backend/mainframe system. It usually uses internal memory and processing power to run one or more applications locally on the client. Thus, a rich-client tends to operate autonomously utilizing its own resources, computing power, etc.

A thin-client traditionally was equivalent to a dumb-terminal but today, is more accurately described as a device that runs on a network and is designed to access a server for most of its functions. Typically a browser renders the user interface for the application described in HTML. A Web server delivers these HTML pages and performs actions on behalf of the user. Thus, the thin-client heavily relies on the processing power and resources of the server and generally is based on a web-architecture.

Within a teller system, the use of a thin-client poses several complexities, including but not limited to the following issues:

In-screen updates. Typically, teller transactions have data that gets updated based on other data entered in the screen. A good example would be calculating fees or loan rates. Implementing transactions using a web-architecture and thin-client would mean either a round-trip to calculate fees, or the business rules captured in scripting. Both are expensive—the former is time-intensive, because it blocks the user while calculating fees. The latter has higher costs, maintaining business rules in multiple locations.

Hot keys. Hot keys improve teller efficiency by improving the speed of transaction invocation. A web-based architecture provides little control over specifying and managing hot keys. In addition, any implementation of hot keys over a web-based architecture imposes significant time delays on teller operation.

Edit Masks. Edit masks are used effectively for syntactic validation of a field. They disallow any inaccurate character to be entered into a field. In web-applications, handling such syntactic validation requires the teller to wait until the next roundtrip (i.e., sending information to the server and waiting for the server to respond). This dramatically decreases the efficiency of the teller.

In-field validation. Field level validation can be done to handle complex syntactic and simple semantic validations. Such measures are effective in stopping the user from leaving a field with bad data. An example could be the expiration date which should be a value that is at least greater than today's date. Like with edit-masks, to implement such validations requires a communication roundtrip.

In-screen validation. Complex cross-field semantic validations can be captured while a transaction is submitted. However, performing such actions in the closest possible tier ensures better teller performance. In web architecture, this needs to be done in the server, while a rich-client could perform this validation on the client, without a network roundtrip.

Offline data. Commonly used data can be cached in the client to improve the responsiveness of the application. For example, in a cross-currency foreign exchange buy-sell, the list of valid “to”—currencies is computed based on the availability of cross-rates from the “from”—currency. In a web application, this would demand a roundtrip and consequently will block the teller from entering data, thereby increasing the time it takes to enter this transaction.

Disconnected mode. A rich client provides an ability to operate even when the network access to the server/host is unavailable. In a web application based on thin-clients, this can be exceedingly difficult to accomplish.

Maintaining session with peer devices. When working with peer-to-peer devices like printers, CDMs, peer-clients, etc., it may be necessary to retain the state of a transaction across multiple screens. This would be quite a challenge in a web-based environment. One example in which it is important maintain the state of a transaction across device and user interactions would be printing on a passbook printer, wherein one might need a user interaction requesting the user to insert the next page of the passbook.

Security in device interactions. Using an applet to manage peer-to-peer device interactions would pose some serious security risks that need to be overcome as well. Particularly, when the device deals with cash—like the Recycler and Cash Dispenser.

The following are several complexities that a rich-client architecture presents in building a teller system.

Deployment. The biggest complexity with a rich-client is managing installation and updates. Each rich-client workstation needs to be individually managed and updated. This tremendously increases the deployment cost of the system.

Maintenance. During a life span of a system, the bank might want to update business processes, introduce new transactions and incorporate learning as validations into the system. But, the ability to perform such maintenance updates to the system becomes complex in a rich-client environment, as the updates have to be pushed to the client one by one.

Portal participation. As the service-based transaction delivery becomes a common theme, banks are increasingly looking to consolidate role-based workplace front-end for the teller. With a web-client it is rather straightforward to build applications so that they can be organized into portlets. With the rich client technology, this is exceedingly difficult.

According to industry analysts, banks spend a considerable amount of funds on technology renewal for the operating branches. This expenditure is ongoing to accommodate further advances in technology. Banks generally adopt new technology with plans to significantly enhance operational efficiencies, increase customer satisfaction and capture new revenue-generating opportunities. There are many options available with thin-client and rich-client infrastructures, and the decision is made all the more daunting when one considers that some branch decisions could be a 10 to 20 year investment. Thus, it is imperative for banks to take a close look at the pros and cons of each technology to determine how to obtain the best of both worlds. Fat-client applications are full-blown applications, residing on the bank's workstation infrastructure, which provide users with full access to the workstation's resources. These fat-client applications have full control over the user interface, allowing for well-designed user interfaces to be highly optimized and efficient and reach across the network only for resources that may not be available on the user's workstation, making the applications more impervious to network outages and reducing the load on shared servers. However, fat-client applications are expensive to deploy and maintain, and often create complex data synchronization issues for a bank's IT staff. These shortcomings have for years motivated the ongoing development and enhancement of thin-client applications—applications that run on a browser, live on a server or farm of servers and require limited client-side processing power. One of the greatest advantages of thin-client environments is the ability to significantly streamline deployment and costs, because thin-client applications do not have to be rolled out on every workstation. Additionally, incremental changes can be deployed more frequently because they can be deployed centrally. At the same time, thin-client environments have significant shortcomings as well: they severely limit the efficiency of the user interface and the level of service delivered to customers; they limit programming control; and their performance and availability are less predictable than fat-client environments, as they rely on servers across the network for most of the resources to get the job done. For example, any time a user interface changes significantly, such as when a user is navigating from screen to screen, a thin client is required to go across the network to the server, which will compute what the next screen should look like; this round trip adds time to teller transactions in an environment where every second and key stroke count. A fat-client application, on the other hand, creates and renders the UI locally, without dependence on a trip to the server.

Thus, there is a need in the art for a teller system that can take advantages of the positive aspects of both the thin-client and the rich-client and eliminate or alleviate the disadvantages of both. Further, there is a need in the art for such a system to provide offline operation with minimal degradation in performance.

Another problem that transaction based industries, such as the banking industry, are faced with is the integration of services. For instance, in the banking industry, customers can interact with the banking institute through multiple points of interface, such as ATM machines, teller windows, telephone service centers, Internet access and across the desk of a bank manager. Traditionally, if a customer desires to initiate a transaction, such as a loan application or a stop payment, the customer must complete the entire transaction using a single point of interface. This restriction on customers can impose significant inconveniences. For instance, if a customer begins filling out a loan application using the Internet and subsequently determines that he or she needs to meet with a bank official prior to completing the application, the customer has to repeat the completed steps with the banking official. Thus, there is a need in the art for a system to integrate the various services and points of interface for transaction based industries.

### BRIEF SUMMARY OF THE INVENTION

The present invention is directed towards providing an integrated services platform that, among other things, satisfies the above-listed needs in the art. In the various embodiments described, users can utilize any of a plurality of available points of interfaces and services to conduct transactions. The integrated aspect of the present invention allows for the data provided to the system to be shared among the various services and to be entered from multiple points of interface. Advantageously, the various embodiments of the present invention are particularly suitable for application within transactional based industries.

In various embodiments of the present invention, the client is primarily a java based rich-client system, where the deployment and maintenance are managed by a deployment protocol such as, but not limited to, java Network Launching Protocol (JNLP) or Open Services Gateway Initiative (OSGI).

In a JNLP oriented embodiment of the present invention, the client can employ a zero-deployment model by using a reference implementation of JNLP called Java WebStart. Java WebStart is an easy to use, free program installer that comes bundled with java runtime environment version 1.4 (JRE). Java WebStart provides a one-click activation to download, cache and maintain the code-base, providing options to automatically integrate with the desktop. WebStart can handle multiple Java runtime environments. Such embodiments of the present invention can utlize JRE 1.4 to run the client. JRE is the minimum standard Java platform for running applications written in the Java programming language. It contains the Java Virtual Machine, Java core classes, and supporting files. Once a user has installed the JRE, it can be used to run any number of applications written in the Java

In an OSGI oriented embodiment of the present invention, the client may utilize Eclipse RCP. Such an embodiment maintains code over OSGI and renders screens using the Standard Widget Toolkit (SWT). Such an embodiment showcases the portal participation capability aspect of the present invention and can utilize the IBM Workplace Client Technology (WCT) to achieve integration across multiple portals from different applications on the front-end.

Aspects of the present invention enable banks to tap into the power, performance and availability of fat-client applications, all while reaping the efficiencies and cost-saving benefits of thin client applications. The present invention is suitable for the banking environment, in which growing competitive pressures force banks to drive down the costs of their system support, upgrades, maintenance and product rollouts. By application of the present invention, banks do not have to deploy applications at each teller workstation manually. Changes to policies, procedures and new product rollouts can be made once at a single location, but will be reflected at all workstations; this administrative shortcut alone can save a bank a substantial sum of funding. The modern day role of bank branches is changing to be focused on relationship building—turning tellers into trusted advisors and giving them the tools to handle interactions as efficiently as possible. Aspects of the present invention enable banks to gain advantages like real-time screen updates, which minimize waiting time and maximize the opportunity to build customer relationships and cross-sell additional services, and the sharing of information.

Branch operations are mission-critical. Banks can't afford their teller systems to go down and have a line of customers wrapped around their branch office, waiting for a system to come back up. Aspects of the present invention not only enable tellers to continue performing transactions for customers when the server is down, but also automatically communicate the stored data back to the server once it comes back on-line. Additionally, the deployment of aspects of the present invention lower the risks faced by teller systems. Embodiments of the present invention can run in a well-defined and well-protected security sandbox and therefore, be less vulnerable to security liabilities. An application running on a platform employing aspects of the present invention can be isolated from other applications. This isolation enables banks to deploy and run multiple applications from multiple vendors that have differing requirements, and avoid, for example, the problems associated with the dynamic link library in the Windows environments and the Java Virtual Machine version—compatibility problem in the JAVA world.

Thus, aspects of the present invention, when incorporated into a teller environment, provide many advantages such as lowering the total cost of ownership, increasing competitive agility, providing greater customer service, allowing predictable operations availability and so on. But the value of aspects of the present invention is amplified within the context of a multi-channel integration strategy, since banks can create, implement and maintain products and processes once, and easily deploy updates across their enterprise. For example, if a customer approaches a teller requesting a funds transfer, the criteria for transferring funds is in the business logic within the bank's front office system. Within an integrated channel environment, a bank's information technology staff can build criteria logic once in a single location that applies to all desired funds transfer requests that come into not only the branch, but also via the call center and over the Internet. Additionally, a smart-client teller application enables a bank to easily extend the same funds transfer rules to off-line teller workstations without rewriting logic at the platform level.

From an infrastructure perspective, there are several standards-based approaches emerging and banks, of course, have the option to buy or build. In the JAVA world, there are applications that rely on the JAVA Network Launch Protocol, which allows applications to be distributed and updated easily. These JAVA systems can work on-line or off-line without being proprietary to any vendor. There are also some additional Microsoft-based technologies, such as ClickOnce, based on NET, and IBM's recently released Workplace Client Technology, as well as Eclipse 3.0 on the Rich Client Platform (RCP), which can enable vendors to build applications that provide banks with all the hybrid benefits addressed above. In addition, some providers have already developed standards-based client applications integrated onto a common platform to help banks take advantage of the best of the fat-client and thin-client worlds. Aspects of the present invention provide a platform on which banks and other similar institutions can deploy such applications and thereby have a highly efficient, robust environment for providing client services.

### BRIEF DESCRIPTION OF THE SEVERAL VIEWS OF THE DRAWING

FIG. 1 is a block diagram of an exemplary client device suitable for operation within a system incorporating aspects of the present invention.

FIG. 2 is a system diagram illustrating a typical environment in which the aspects of the present invention can be incorporated.

FIG. 3 is a conceptual diagram illustrating the integration obtained by employment of aspects of the present invention.

FIG. 4 is a general flow diagram illustrating the operation of a system that incorporates aspects of the present invention.

### DETAILED DESCRIPTION OF THE INVENTION

The aspects of the present invention are directed towards providing a system that integrates multiple points of access and services available to users. One component of the system includes the deployment of client devices that enable the merging of functionality and off-line capabilities available for rich-client platforms with the ease of upgrade and maintenance available for thin-client platforms. In addition, aspects of the present invention allow for the integration of an ASP type model into an environment, such as a banking environment, in which the overall architecture of an ASP type model is not directly suitable due to, among other things, the lack of security and the round trip data delivery lags due to interfacing to a server. Additionally, aspects of the present invention facilitate the provision for the deployment of mission critical applications onto remote, front end, workstations. Thus, the present invention enables a front-end workstation to operate in an ASP type model in which the application programs, data and transactions can be seamlessly shared with other transactions and can be initiated and/or completed using multiple points of access.

Turning now to the figures in which like numerals and labels refer to like elements, the various aspects and embodiments of the present invention are described in more detail.

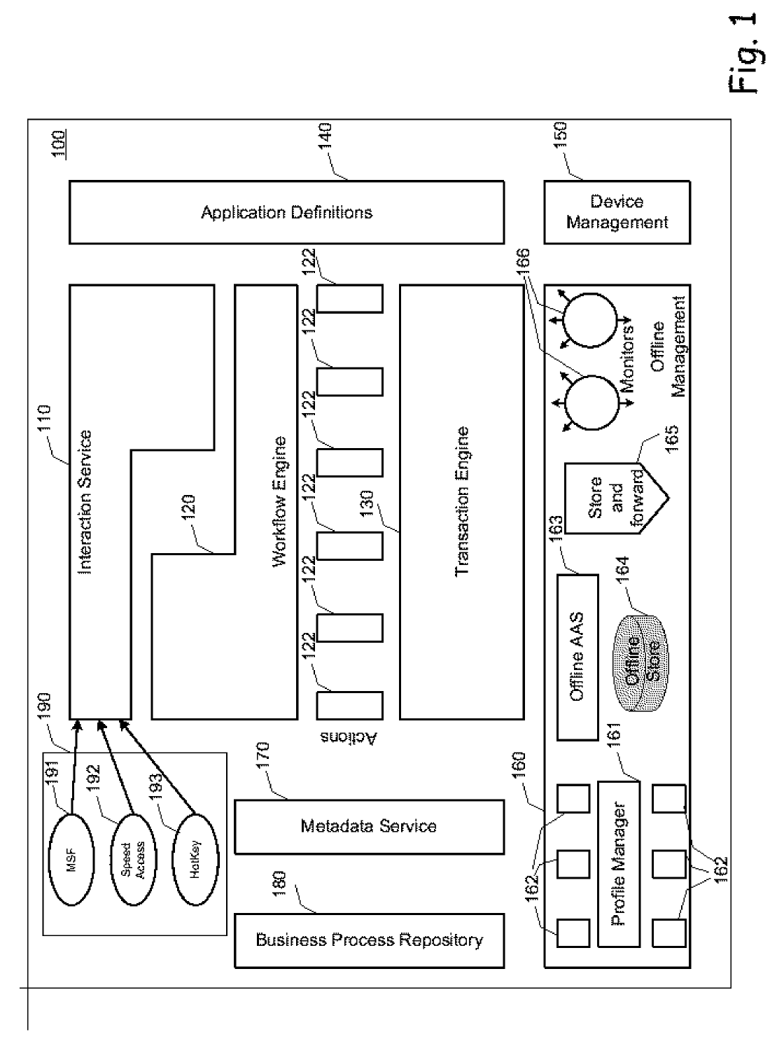

FIG. 1 is a block diagram of an exemplary client device suitable for operation within a system incorporating aspects of the present invention. The diagramed client device is a typical client device that can be employed in various environments and implement various aspects of the present invention. The client device 100 includes an interaction service block 110, a workflow engine 120, a transaction engine 130, application definitions 140, device management block 150, offline management block 160, metadata service 170 and a business process repository 180 and client device interface 190. It should be understood that the particular structure illustrated in FIG. 1 and described herein is simply for illustrative purposes. The particular demarcation of the various functions and features can be described in a variety of manners, can be combined into a fewer number of blocks or separated out into a larger number of blocks.

A user, process or machine can interface to the client device 100 through the various interface mechanisms available through the client device interface 190. As illustrated, the client device interface can include a menu structure framework 191, speed access 192 and one or more hotkeys 193. Thus, for a user interacting with the client device 100, the user can select one or more hotkeys to invoke functions, enter repetitive data or the like. It should be understood that the client device interface 190 can include a variety of other input and output mechanisms including, but not limited to a display device, audio output devices, printers, mouse devices or other pointing devices, signature pads, keyboards or the like.

The interaction service block 110 processes any input received from the client device interface 190 and prepares the presentation of any data to be provided to the client device interface 190. The interaction service block 110 interacts with the workflow engine 120 to provide received data, requests, transactions, application invocations or the like, and receives response data from the workflow engine 120. More specifically, the interaction service block 110 is primarily responsible for the entire user interface of the client device 100. As such, the interaction service block 110 controls the graphical user interface, the menu structure framework and any other user-like interfaces to the client device 100. For instance, in a teller workstation environment, the interaction service block 110 may display a screen for performing a withdrawal. As the teller interacts with the bank customer, the teller can enter necessary information into the client device 100 by filling in particular fields in the withdrawal screen. The teller may enter a few items, such as the customer name, the account number and the amount of funds to be withdrawn. Upon completion of this information, the interaction service block 110 may generate an additional screen requesting further information. Once all of the information necessary to effectuate the withdrawal of funds, the interaction service block 110 can invoke a process to perform the withdrawal service.

The functions, applications or processes invoked through the interaction service block 110 are provided through cooperation of the workflow engine 120, the application definitions 140, the business process repository 180 and the metadata service 170. Each of these blocks cooperatively define and house the intelligence for providing the functionality of client device 100. The client device 100 can support a variety of functions and/or applications and, over a period of operation, the available functions and/or applications can be modified by either adding new functions, deleting functions, or augmenting or diminishing the functionalities of various functions and/or applications.

When the interaction service block 110 accumulates the necessary information to invoke a function or application, the interaction service block 110 calls the appropriate workflow function through the workflow engine 130. This process can include formatting the acquired information into the appropriate format and passing the acquired information to the workflow engine 130 as a function call, although it will be appreciated that other techniques for providing the acquired information to the workflow engine 130 could also be employed such as, but not limited to, pushing the data onto a stack or providing a pointer to the appropriate memory location within the interaction service block 110.

The application definitions 140 define, at a high-level, what transactions are available for the client device 100 at any particular time. In generating user screens, the interaction service block 110 interfaces to the application definitions 140 to generate a menu of selectable functions based on the current state of the client device 100. For instance, the home screen of the client device 100 may list a menu of operations, such as, withdrawal, funds transfer, balance checking, account creation, card issuance, etc. In generating this home screen, the interaction service block obtains the currently available functions from the application definitions 140. It should be appreciated that the interactions service block 110 may also obtain this list through the workflow engine 120 without having to directly interface with the application definitions 140.

The application definitions 140 may also house the definitions for various hot-keys and speed access codes. For instance, a teller may invoke a funds transfer by pressing a single hot key (i.e., Function 9) which results in invoking the display of the withdrawal screen. The definitions for such hot-keys can reside within the application definitions 140.

The business process repository 180 maintains a library of processes, sub-routines, functions, or the like, and can best be described as a library of functions. When a function or application defined in the application definitions 140 is invoked, the workflow engine 130 operates to build a workflow process by extracting or invoking the functions or processes within the business process repository 180 in accordance with the definition of the function or application obtained from the application definitions 140.

The business process repository 180 describes the process to be performed. Each process within the business process repository 180 includes a collection of steps and business rules that are executed to perform the process. The steps may include further interactions with the customer or teller through the interaction service block 110, may invoke an action in cooperation with a backend server, may invoke a business rule that augments or modifies the process, or may include another process or sub-process. As an example, the following steps may be included in a process to request a funds withdrawal:

Step 1—Validate customer information process

Step 2—If customer balance is greater than $500 then go to Step 4, otherwise

Step 3—Invoke supervisor sign-off process

Step 4—Invoke funds withdrawal

The workflow engine 120 operates akin to a complier or interpreter. When an action is invoked through the interaction service block 110 or otherwise, the workflow engine 130 identifies the appropriate application definition in the application definitions 140 and pulls the necessary processes from the business process repository 180 to perform the action. As previously mentioned, the action may require additional interaction with the interaction service block 110. In such a situation, the workflow engine 120 communicates with the interaction service block 110 to modify or augment the user interface and obtain the necessary information, confirmations, etc. The workflow engine 120 also interacts with the transaction engine 130 to perform certain tasks. The workflow engine 120 creates actions 122 that are to be performed through the transaction engine 130. The workflow engine 120 can create multiple actions to be operated on by the transaction engine 130. For each such action, the workflow engine provides the necessary data, identifications and information required for the transaction engine 130 to perform the action. For instance, if the action is a request to perform a funds transfer, the action may include an identification of the customer, the amount of funds to be transferred, the account the funds are to be withdrawn from and the account into which the funds are to be transferred. In addition, the action may indicate that appropriate authorizations for conducting the action have been obtained.

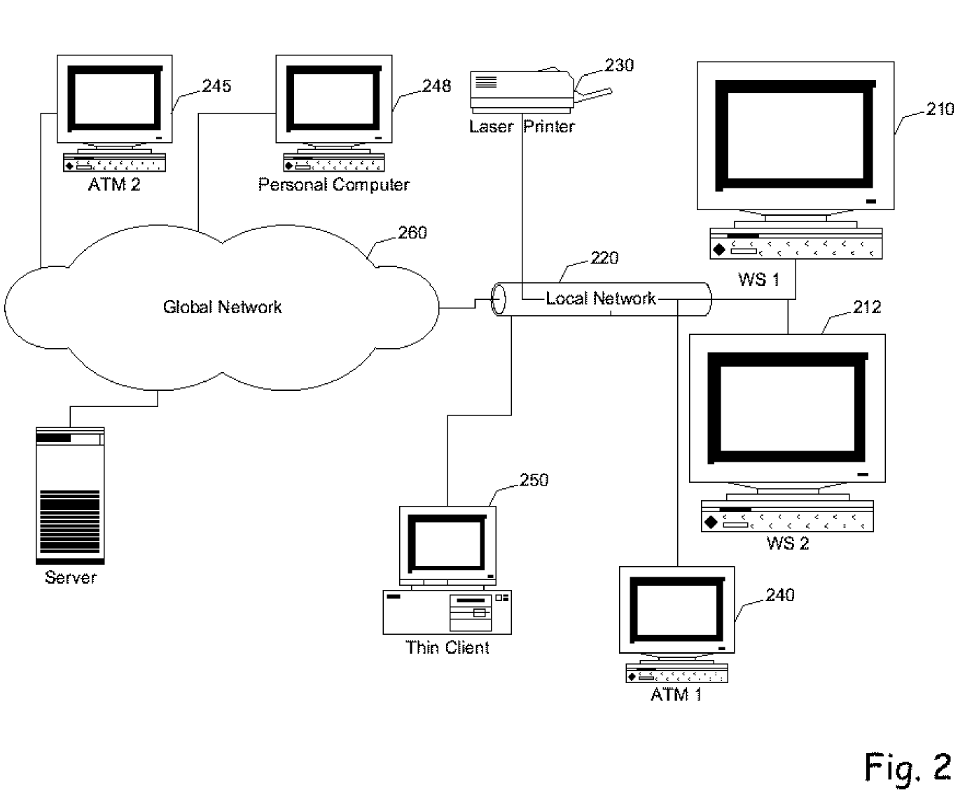

The transaction engine 130 operates differently depending on the mode of operation—on-line or offline. During on-line operation, the transaction engine 130 interacts with a server and during offline operation with the offline management 160. This operation will be described in more detail in conjunction with the discussion of the offline management 160 and with regards to FIG. 2. However, in general the transaction engine 130 operates in on-line mode to ensure that communication with the backend system or server is bundled appropriately, sequenced appropriately and verifies the execution. In the offline mode, the transaction engine 130 ensures that requested transactions are placed into the offline store and that the transactions are subsequently performed when online operations have resumed.

The metadata service 170 provides further customization to the available functionality of the client device 100. This aspect of the client device 100 allows various aspects and operations of the client device 100 to be easily modified without having to modify the core functionality of the application definitions 140 or the business process repository 180. For instance, the user screens can be easily modified or augmented through the use of the metadata service 170. Such augmentations could include the display of additional fields within the screen, on-line help notes to assist the completion of screens if and when it is determined beneficial. Another augmentation could be for providing additional information about a customer. If a workflow process requests all information about a typical customer, the hard-coded information about the customer can be extracted and, any additional information that may be required for the particular branch or company can be obtained by a query of the metadata service 170.

The device management 150 enables the client device 100 to interface with other devices that are connected through a local area network and manages such interactions. Any necessary device drivers for devices connected to the client device 100, either directly or over the local area network can be loaded into the device management 150. In addition, the device management 150 can discover devices that are accessible to the client device 100, ensure that the necessary drivers are in place, current and active, and verify that the devices are available. The device management 150 enables all communication with the client device 100 to be conducted on a peer-to-peer basis thus, allowing interaction with the devices even if the backend server or wide area network are not operating. The device management 150 performs simplistic operations such as acting as a buffer for printers, to more complicated operations such as managing the delivery of requests to various devices, ensuring proper sequencing of activities, filtering out redundant requests, and verifying messages are sent to and properly received by a device. As an example, if a teller requests a balance to be printed on a customer's passbook, the device management 100 can ensure that the request has been properly delivered to the printer and that the correct passbook has been placed into the printer.

FIG. 2 is a system diagram illustrating a typical environment in which the aspects of the present invention can be incorporated. The illustrated scenario includes two client devices 210, 212 as described in conjunction with FIG. 1, that are communicatively connected over a local area network 220. Also residing on the local area network 220 is a printer 230, an automatic teller machine (ATM1) 240 and a thin client 250. The local area network 220 interfaces to a wide area network 260, such as the Internet, to gain access to a server 270. The server 270 is of similar construction, with regards to functionality, as the client device 100 illustrated in FIG. 1. Each of the processes and/or applications available in the client device 100 is first created on the server 270. The server 270 is able to operate in a multi-channel environment interfacing to both client devices 100, as well as thin clients such as thin client 250, ATM devices such as ATM1 240 and ATM2 245 and personal computer 248. The server 270 is also operable to operate as the backend processor for the overall application, such as a banking operation, or alternatively, as the interface to the backend processor.

Each of the processes or applications available to the client device 100 are first created, and maintained within the server 270. When a virgin client device 100 is attached to the server 270 and powered up (for example client devices 210 or 212), an image of the processes and/or applications available to the client device are loaded from the server. As functions or applications are modified, such changes take place on the server and are then uploaded to the client devices upon subsequent power ups or on the fly. It should be understood that the present invention requires only the portions of the processes or applications that have changed to be reloaded. Thus, the client devices are maintained and kept current by modifying a single platform—the server 270.

In operation, processes or applications that are invoked by the client devices operate as described above. However, if a thin client is attached to the local area network, the same functionality that is available to the client devices is available to the thin client. In the thin client scenario, rather than invoking actions through the cooperation of the application definitions 140, the business repository 170, the metadata service 130, the workflow engine 120 and the transaction engine 130, all located on the client device, mirrored counterparts of these functions residing in the server 270 are invoked.

Thus, upon applying power to a client device 100, all of the current processes and applications are loaded into the client device using technology such as JNLP or OSGI. Advantageously, the client devices house all of the functionality that is available on the server side and, can operate in an offline mode regardless of the availability of the server 270.

As shown in FIG. 2, the server 270 operates as the central system for the devices attached to the local area network 220, as well as devices attached to the wide area network 260. This aspect of the invention is uniquely suitable for providing the integration of services and access points for the system. With the distributed architecture of the present invention, a user can complete a transaction using one or more interface points or can receive multiple services from the system and have the benefit of shared information. For example, a user can access the system via the Internet using personal computer 248 and begin filling out an application for a business loan. Advantageously, the user can do this from the comfort of his or her home or office where the user has access to the pertinent information. All of the information entered via the personal computer 248 is obtained by the server 270 as the personal computer 248 operates similar to that of a thin client. The user can then approach a teller that is using a client device 210 at a branch office. The user can work with the teller to complete the loan application. The distributed architecture of the present invention enables the information entered by the user via the Internet to be accessed by the teller using a client device. Similarly, a user can initiate a loan application with a teller using a client device and then complete the application at home using a personal computer.

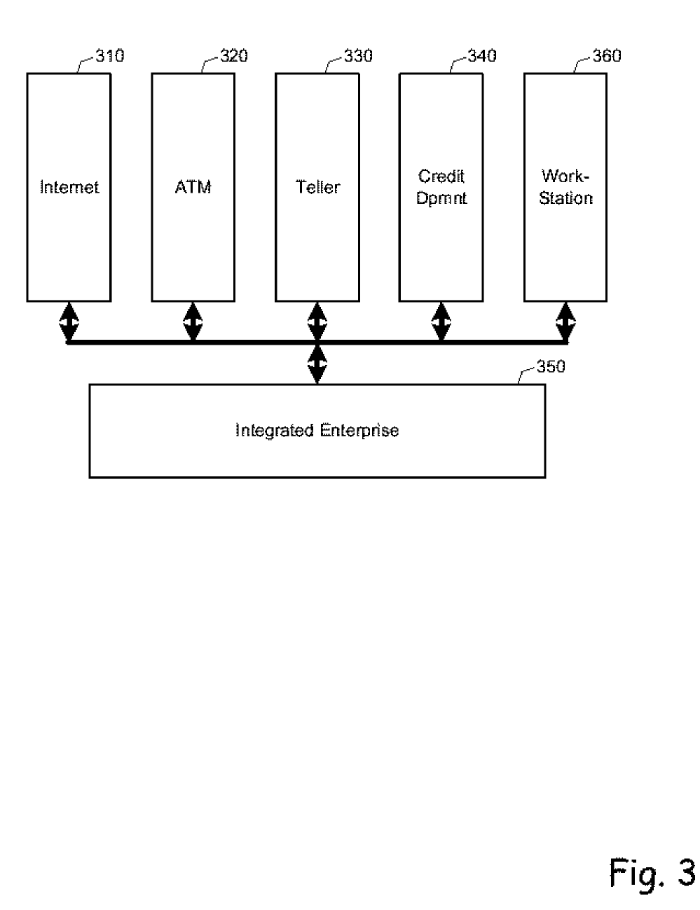

FIG. 3 is a conceptual diagram illustrating the integration obtained by employment of aspects of the present invention. Five access points are illustrated including the Internet 310, and ATM 320, a teller 330, the credit department 340 and a workstation 360. Each of these access points represents some of the silos through which a banking institute can provide services to a client. An enterprise services platform 350 allows for the integration of each of the silos. The enterprise services platform 350 can comprise a server 270 as described in conjunction with FIG. 2. Using this architecture, the enterprise services platform can provide each of the available services through any or a select number of the silos. These services can be provided to thin-clients or to client devices as described in conjunction with FIG. 1 (i.e., workstation 360). All of the information received through one of the silos can be made available to any or a select number of the other silos by either making the information available through the enterprise services platform 350 or pushing the information to client devices. In addition, the financial services that can be provided by the enterprise services platform can share a common definition of applications and rules that are utilize or applied in providing the financial services. These applications and rules are either invoked directly in the enterprise services platform through the access point, or are provided using an image of the applications and rules that run autonomously or pseudo-autonomously at the access point. This capability is obtained, in part due to the architecture employed within the enterprise services platform 350 which contains all the functionality for the entire system. The functionality can be made available to particular devices that access the enterprise services platform 350 in several manners. For client devices as described in FIG. 1, the functionality of the system is loaded into the client devices to enable them to operate in an on-line or offline mode of operation. Any data entered into the system, including partially completed transactions, can be accessed by other devices or access points as deemed appropriate by the enterprise services platform 350. In addition, information entered at one access point for a particular transaction can also be accessed and utilized by another access point for a different transaction. Because all of the applications and business rules are created only once, and are maintained at a single location, the services or transactions being initiated, furthered, or completed on the various access points can be integrated into the single platform and be subject to updated rules.

Offline Operation

Returning again to FIG. 1, the offline management block 160 houses several aspects of the present invention. The offline management block 160, as well as the other functional blocks within the client device 100 are loaded upon initially bringing the client device 100 online, and can be subsequently updated throughout the life of the client device. The offline management block 160 includes a profile manager 161 that manages and maintains multiple profile definitions 162, an offline authentication and authorization service (ASS) 163, on offline store 164, a store and forward function 165 and activity monitors 166.

More specifically, the offline management block 160 enables the client device 100 to operate as a stand-alone device, yet reap the benefits of a highly integrated thin client platform. The majority of the functionality necessary for the client device to fully perform the necessary tasks is loaded into the offline management block. Upon powering up of a virgin client device 100, all of the functions necessary for the client device 100 to operate are loaded into the client device 100. Once fully loaded, the client device can operate in either an on-line or offline mode seamlessly. Thus, regardless of whether the client device 100 is attached to a network, or the backbone network is operating, the client device 100 is fully functional. Upon subsequent powering up of the client device 100, it is not necessary to load all of the functionality back into the client device 100. Rather, the client device can simply be checked and verified to determine if any upgrades or changes in the functionality of the client device 100 are necessary, and if so, only the portions of the functionality that have changed since the last power up or update are loaded into the client device 100.

The profile manager 161 maintains various user or access profiles 162. When a user or device attempts to access the client device 100, the profile manager 161 is invoked to determine the access privileges and functionality of the client device 100. For instance, in the teller environment, each teller may be given a profile. Alternatively, various classes of tellers may share a profile. The profile 162, regardless of the mapping to users, can establish the access and functionality for of the client device 100 for the accessing user or device. Thus, a junior teller that access the client device 100 may be limited to only access certain transactions, may be required to obtain a supervisor approval for other transactions and can be restricted based on other criteria such as hours of operation, value of transactions being processed, volume of transactions allotted for a particular period of time, amount of cash the teller is allowed to accumulate in the teller till drawer, etc.

The offline AAS 163 operates to authenticate and authorize requested services for offline operation. Thus, if the client device 100 is not able to communicate with the back end systems, the offline AAS 163 can verify that a request transaction can be approved. Such authentication and authorization is performed at a run-time level meaning that each and every access can be subjected to the scrutiny of the offline AAS 163. The offline AAS 163 also operates to verify the credentials of a user accessing the client device 100. Thus, prior to granting a teller access to the client device 100, the offline AAS 163 verifies that the client is authorized, and what levels of authorization are to be granted.

The AAS maintains three buckets of information: user level, terminal level and global level information. The user level bucket includes user specific data. This information includes, but is not limited to the authentication credentials of the various users and transactional data. The transactional data can include a running electronic journal of all transactions requested and/or performed by a user of the client device 100. For instance, the transactional data may include running totals of cash in and cash out for a specific teller, the amounts of foreign currency received, the number and types of transactions performed, etc. The terminal level bucket includes information specific to the particular client device 100. This information can include what devices are attached or are accessible to the client device 100, the hours of operation of the business in which the client device 100 operates and capabilities available to various users (i.e., junior tellers, senior tellers, supervisors, etc). The global level bucket includes information pertinent to each of the client devices in the system. For instance, fee structures for a branch or the bank in general can be stored in this bucket. Thus, as fees change on a regional basis, the various client devices can be updated accordingly. When the business process repository is creating processes for the workflow engine 120, the rules available in the AAS 160 can be accessed and incorporated into the workflow process.

The store and forward function 165 serves as the transaction communication point for offline operation of the client device 100. When transactions are received from the transaction engine 130, the transactions are properly formatted, authenticated by the offline AAS 163. If the client device 100 is presently in communication with the back end system, the transaction can be immediately sent for processing. However, in offline mode the transactions are then stored in the offline store 164. When the client device is back on-line, the store and forward function 165 extracts the transactions from the offline store and sends them to the backend server. The client device 100 can also utilize the offline store 165 and the store and forward function 165 during online operation to warehouse the various transactions in an effort to regulate bandwidth requirements or as a result of network congestion or to prevent server overrun. The store and forward function 165 delivers and updates information in a seamless manner so that the users are not aware that the client device 100 is working in an offline mode of operation.

The monitors 166 are configurable monitors. The intelligence for the operation of the monitors is loaded into the client device 100 from the server 270. Among other things, the monitors operate to monitor the activity of the client device 100 and provide alerts such as, determining if the server is reachable, is the host available, is the network up or down, etc. For instance, the monitors may monitor the network to detect when it is online and then invoke the store and forward function to begin the delivery of transactions. Thus, when certain monitored activities are detected, the monitors 166 may send out event notices to various other components within the client device 100. Such events can be used to modify the operation of the client device 100. For instance, if the client device is operating offline, the user interface may be modified to require additional or different information. More specifically, during online operation, a customer may simply be required to enter a customer identification to invoke a particular transaction. The client device 100, using the customer identification can obtain account information, such as account numbers, from the server 270 for that particular customer. However, in offline operation, the client device 100 may not be able to obtain the account information and thus, the user interface can be modified to require the customer to provide the account number rather than simply a customer identification.

The device management block 150 maintains a list of devices that can be accessed by the client device 100. For instance, if a client device 100 is to have access to a signature pad, a check printer and a cash dispenser, all of the information necessary to access and interface to these devices is loaded into the device management block 150. Thus, regardless of whether the client device 100 is operating in an on-line or offline mode, the client device 100 will have the necessary information to interface to these devices. This is true even if the devices are not directly connected to the client device 100 but rather, are accessed over a local network or IP network and are shared devices.

In operation, suppose that a branch office includes several work stations. Two of these work stations are to be granted access to a particular device (i.e. Printer One). The present invention allows the drivers for Printer One to be downloaded to these work stations in the background and automatically configures the Printer One for access by the work stations. Alternatively, the client device 100 can discover the device and configure the work stations to access the device.

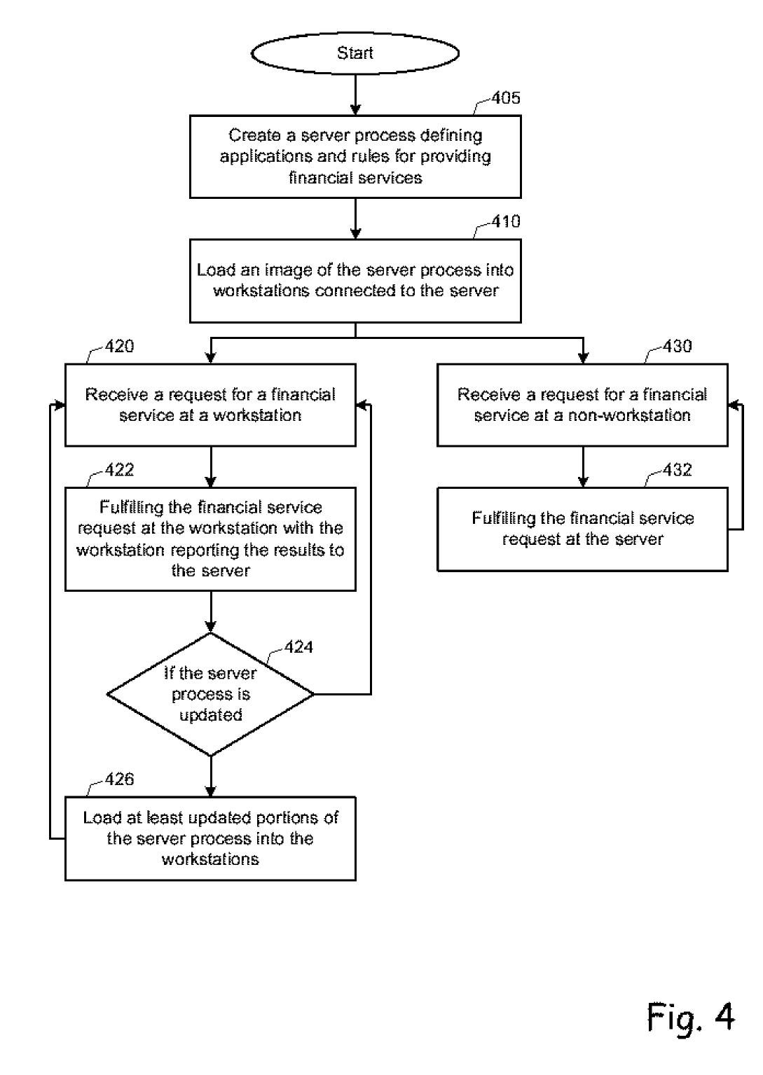

FIG. 4 is a general flow diagram illustrating the operation of a system that incorporates aspects of the present invention. This flow diagram is not intended to show any particular order for processes performed in the provision of integrated financial services but rather, shows the relationship of multiple types or classes of devices through which the integrated financial services can be provided. Although the classes of devices are shown as only including workstations, as defined as client devices depicted in FIG. 1, and non-workstations, it will be appreciated that within each class, multiple types and configurations of devices may exist. Certain attributes for client devices as defined in FIG. 1 can be incorporated into non-workstation class devices and visa versa. Each class of devices may include similar functional items such as ATMs, menu drive telephone systems, teller terminals or the like. The general distinction between the two classes is to illustrate the integration of financial services available to access point that either operate as thin-clients that heavily rely on the server based functionality or devices in which substantial functionality is loaded and that operate autonomously or pseudo-autonomously.

At block 405, the flow diagram illustrates that a server process that contains the applications, rules and data necessary to provide a suite of financial services is created. At block 410, an image of this server process is loaded into the workstation class of devices. The image may include an exact functional representation of all of the available financial services including the applications and rules, or may only include a portion thereof. Blocks 420 and 430 illustrate that requests for financial services can be received in parallel or independently at the workstation class of devices and the non-workstation class of devices that are communicatively coupled to a server that houses the server process.

For the workstation class of devices, the request for the financial service is fulfilled by the workstation and the results, such as a transaction, are then provided or reported to the server at block 422. Decision block 424 illustrates that if the server process is modified, at least the portions of the applications, rules and data that are modified can be loaded into the workstation at block 426. It should be appreciated that many financial services can be fulfilled by the workstation between such updates and the timing for loading the updated process into the workstations can be any of a variety of timings such as, but not limited to, subsequent powering up of the workstation, at the time a user logs into the workstation, between each financial service fulfilled by the workstation or simply periodically. In either case, the overall system continues to operate in a manner to accept financial service requests at the workstation and fulfill the requests.

For the non-workstation class of devices, the request for the financial service 430 is fulfilled by the server 432. The server can provide all of the user interface control to the non-workstation device or the non-workstation device may control the user interface and rely on the server for the fulfillment of the service requests. In the former case, any updates to the server are immediately available for processing financial service requests and nothing is required to be loaded to the non-workstation class device. In the latter case, the non-workstation device is really a limited version of a workstation class device and as such, only changes that impact the user interface must be loaded.

It should be appreciated that this example illustrates the integration of financial services for two extreme classes of devices and that the present invention is also applicable for hybrid devices that fall within these two extremes.

The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art.

What is claimed is:

1. A system for integrating a plurality of financial services, the system comprising:
a first processing device in which is contained a master definition of the financial services available to the system including the applications and the business rules applied when invoking the financial services; and
a plurality of access points to the system, each access point providing at least a portion of the financial services to users of the system with each such portion of the financial services relying on the applications and business rules contained in the first processing device.

2. The system of claim 1, wherein at least one of the plurality of access points is a workstation, the workstation including:
a user interface;
an interface to the first processing device;
an offline manager that interacts with the first processing device when the first processing device is online; and
a workstation-based processing function that interacts with the user interface and the offline manager, is loaded into the workstation by the first processing device and is an image of at least a portion of the master definition.

3. The system of claim 1, wherein at least one of the plurality of access points is a workstation, the workstation including:
a user interface;
an interface to the first processing device;
an offline manager that interacts with the first processing device when the first processing device is online; and
a workstation-based processing function that interacts with the user interface and the offline manager by:
receiving a request for a financial service from the user interface;
generating a process flow to perform at least a portion of the financial service;
performing the at least a portion of the requested financial service and providing a transaction to the offline manager;
the offline manager being operable to:
detect when the first processing device is online; and
provide the transaction to the first processing device.

4. The system of claim 3, wherein the workstation based processing function is loaded into the workstation by the first processing device and is an image of at least a portion of the master definition.

5. The system of claim 4, wherein any subsequent changes to the master definition are loaded into the workstation.

6. A system for integrating a plurality of financial services, the system comprising:
a server including a server-based processing function defining the business rules and applications available to the system;
a plurality of workstations with each workstation including a client-based processing function that is loaded from the server and is an image of at least a portion of the server-based processing function; and
a plurality of other devices, each such device having access to the server and operable to execute one or more applications available on the server and utilize the business rules when providing financial services,
whereby the financial services are made available to each of the plurality of workstations and each of the plurality of other devices with each such financial service relying on the applications and business rules defined in the server-based processing function.

7. The system of claim 6, wherein the plurality of other devices can be one of a group of devices including ATMs, thin terminals, and telephone access systems.

8. The system of claim 6, wherein the client-based processing function for each of the workstations is loaded into the workstation from the server upon virgin power up.

9. The system of claim 8, wherein upon subsequent power ups of each workstation, any changes that have been made to the server-based processing function in the server are loaded into the workstation.

10. The system of claim 8, wherein the loading of the client-based processing function into the workstation is performed using JNLP technology.

11. The system of claim 8, wherein the loading of the client-based processing function into the workstation is performed using OSGI technology.

12. A system for providing ASP type operation to a plurality of devices while integrating the provision of financial services, each of the plurality of devices being communicatively coupled to a server, the system comprising:
a server including a server-based processing function defining as set of applications and rules necessary to provide the financial services;
a first class of devices of the plurality of devices being a workstation class of devices with each workstation class of devices including:
a user interface;
an interface to the server;
an offline manager that interacts with the server when the server is online; and
a client-based processing function is loaded from the server and includes an image of at least a portion of the server-based processing function, the client-based processing function being operable to interact with the user interface and the offline manager by:
receiving function requests from the user interface;
generating a process flow to perform the requested function;
performing the requested function and providing a transaction to the offline manager; and
a second class of devices of the plurality of devices being a thin-client class of devices with each thin-client class of devices including an interface to the server thereby allowing the server-based processing function to:
receive function requests from the thin-client class of devices;
generate a process flow to perform the requested function;
perform the requested function;
whereby the financial services are integrated in that they are provided from a common set of applications and rules that are maintained in the server.

13. A method for providing integrated financial services to a plurality of diverse access points, the method comprising the steps of:
creating server processes to run on a server, the server process including applications and rules necessary to provide the financial services;
communicatively coupling a plurality of workstations to the server;
loading an image of the server processes into each of the workstations;
receiving a request for a financial service at a workstation;
fulfilling the financial service request at the workstation based on the loaded image of the server processes;
the workstation providing a report of the fulfillment of the financial service to the server;
communicatively coupling a plurality of non-workstation devices to the server;
receiving a request for a financial service at a non-workstation device;
fulfilling the financial service request at the server;
whereby financial service requests received by workstations or non-workstations are fulfilled using the same applications and rules thereby integrating the financial services.
transmitting the transaction to the server; and
loading the changes incurred in an upgrade of one or more of the processes to each client device.
